(19) United States
(12) Patent Application Publication
(10) Pub. No.: US 2025/0262910 A1
(43) Pub. Date: Aug. 21, 2025

(54) ROOF VENT BLIND

(71) Applicant: RICHARD ADRIAN HILARY OLPHIN, Blythe Bridge (GB)

(72) Inventor: RICHARD ADRIAN HILARY OLPHIN, Blythe Bridge (GB)

(21) Appl. No.: 18/442,777

(22) Filed: Feb. 15, 2024

(30) Foreign Application Priority Data
Feb. 15, 2023 (GB) 2302165.2

(51) Int. Cl. B60H 1/26; B60H 1/24

(52) U.S. Cl. CPC B60H 1/262; B60H 1/245

(57) ABSTRACT

Examples of the disclosure relate to a roof vent blind. The roof vent blind for a recreational vehicle comprising: a cover portion, configured to suspend below a roof vent and at least partially cover the interior footprint of the roof vent; at least one air flow portion. The air flow portion comprises at least one air flow conduit configured to enable air flow between the interior and exterior of the recreational vehicle through the roof vent.

### CROSS-REFERENCE TO RELATED APPLICATIONS

This application claims priority to United Kingdom Application No. 2302165.2, filed Feb. 15, 2023, the entire contents of which are incorporated herein by reference.

### TECHNOLOGICAL FIELD

Examples of the disclosure relate to a roof vent blind. Some relate to a roof vent blind for a recreational vehicle.

### BACKGROUND

Recreational vehicles frequently comprise roof vents to control ventilation in the recreational vehicle. Roof vent blinds can be used to reduce light transmission into the interior of a recreational vehicle through a roof vent. It is desirable that the roof vent blind can be configured to reduce light from the roof vent when shade is desired within the recreational vehicle. This could be useful if the occupant of the recreational vehicle is trying to sleep or requires a dark environment for any other purpose.

### BRIEF SUMMARY

According to various, but not necessarily all, examples of the disclosure there may be provided a roof vent blind for a recreational vehicle comprising: a cover portion, configured to suspend below a roof vent and at least partially cover the interior footprint of the roof vent; at least one air flow portion; wherein the air flow portion comprises at least one air flow conduit configured to enable air flow between the interior and exterior of the recreational vehicle through the roof vent.

The air flow conduit may comprise at least one of: an air maze; an aperture.

The air maze may comprise at least one light baffle, and the light baffle may comprise at least one air flow aperture.

The air maze may comprise two or more light baffles.

The air maze may comprise two or more light baffles, and the light baffles may be configured to enable air flow between at least one air flow aperture of a first light baffle and at least one air flow aperture of a second light baffle.

The air maze may comprise two or more light baffles, and the light baffles may be configured such that at least one air flow aperture of a first light baffle is positionally offset with respect to at least one air flow aperture of a second light baffle.

The air maze may comprise two or more light baffles, and the light baffles may be configured to obstruct straight-line paths through the roof vent and the air maze.

The air flow conduit may be at least one of: substantially equivalent in size to the air flow portion; substantially smaller in size than the air flow portion.

The roof vent blind may comprise non-reflective material.

The non-reflective material may comprise at least one of: nano-fabric; flocking.

The roof vent blind may be configured to be detachably coupled to the ceiling of the recreational vehicle.

The roof vent blind may be configured to be detachably coupled to the ceiling of the recreational vehicle using hook and eye coupling means.

The roof vent blind may be configured for use with a roof vent comprising at least one roof vent fan.

The roof vent fan may be configurable for high volumetric air flow rate operation.

The roof vent blind may be configured to enable air flow between the interior and exterior of the recreational vehicle through the roof vent, while substantially reducing light transmission into the interior of the recreational vehicle through the roof vent.

The roof vent blind may comprise substantially opaque material configured to reduce light transmission into the interior of the recreational vehicle through the roof vent.

The roof vent blind may be sized and shaped to reduce light transmission into the interior of the recreational vehicle through the roof vent.

The recreational vehicle may comprise at least one of: a caravan; a campervan; a motorhome; a coach; a fifth-wheel trailer; a pop-up camper; a truck camper.

### BRIEF DESCRIPTION OF THE FIGURES

Some examples will now be described with reference to the accompanying drawings in which:

FIG. 1 illustrates a system in which some example embodiments may be used for digital product management. FIG. 1 shows a perspective view of an example roof vent blind;

FIG. 2 shows a lateral view of an example roof vent blind;

FIG. 3 shows another lateral view of an example roof vent blind;

FIG. 4 shows a top-down view of an example air flow conduit;

FIG. 5 shows a top-down view of an example roof vent blind.

The figures are not necessarily to scale. Certain features and views of the figures can be shown schematically or exaggerated in scale in the interest of clarity and conciseness. For example, the dimensions of some elements in the figures can be exaggerated relative to other elements to aid explication. Similar reference numerals are used in the figures to designate similar features. For clarity, all reference numerals are not necessarily displayed in all figures.

### DETAILED DESCRIPTION

Roof vent blinds for recreational vehicles can typically be moved between two configurations. In a first configuration the roof vent blind is closed which reduces light transmission into the interior of the recreational vehicle through the roof vent but blocks air flow between the interior and exterior of the recreational vehicle through the roof vent. In a second configuration the roof vent blind is open which does not reduce light transmission but enables air flow. In warm conditions it is often desirable for the interior of the recreational vehicle to remain shaded while enabling air flow to promote cooling.

Examples of the disclosure relate to roof vent blinds for recreational vehicles which offer improved shading and cooling, thus enhancing the comfort of occupants.

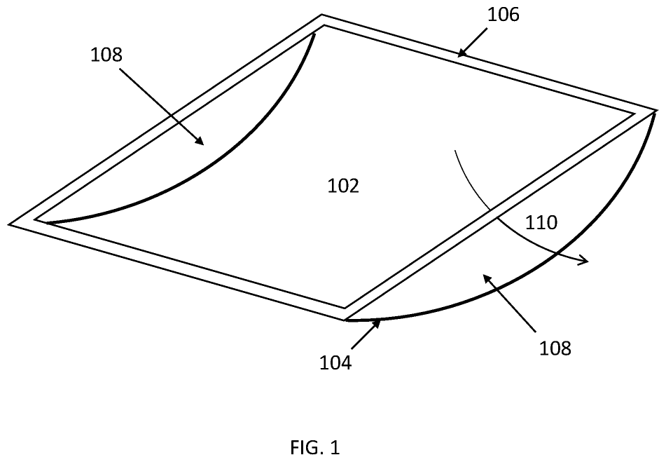

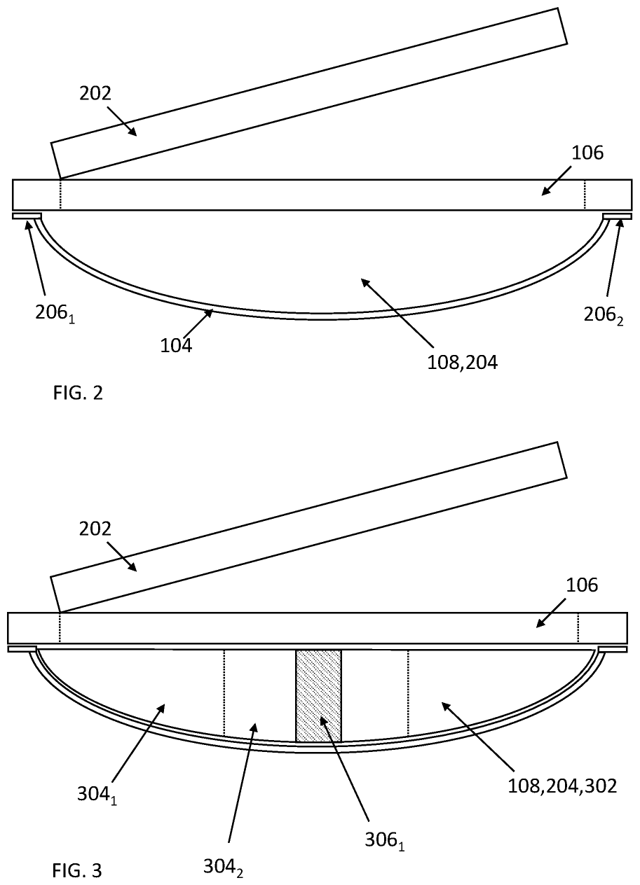

FIG. 1 shows an example roof vent blind 102 for a recreational vehicle. The example roof vent blind 102 for a recreational vehicle comprises a cover portion 104, configured to suspend below a roof vent 106 and at least partially cover the interior footprint of the roof vent 106. The example roof vent blind 102 further comprises at least one air flow portion 108, wherein the air flow portion 108 comprises at least one air flow conduit 204 (see FIG. 2) configured to enable air flow between the interior and exterior of the recreational vehicle through the roof vent 106.

The curved arrow 110 in FIG. 1 illustrates air flow through the roof vent 106 and one of the air flow portions 108.

The roof vent blind 102 may be configured to be coupled to the ceiling of the recreational vehicle. The roof vent blind 102 may be configured to be coupled to the ceiling of the recreational vehicle at least partially surrounding the interior footprint of the roof vent 106. The roof vent blind 102 may be configured to be coupled to the frame of the roof vent 106. The ceiling of the recreational vehicle may comprise the frame of the roof vent 106.

The roof vent blind 102 may be configured to enable air flow between the interior and exterior of the recreational vehicle through the roof vent 106, while substantially reducing light transmission into the interior of the recreational vehicle through the roof vent 106.

The roof vent blind 102 is configured to enable air flow because the roof vent 106 comprises at least one air flow portion 108, wherein the air flow portion 108 comprises at least one air flow conduit 204.

The air flow conduit 204 enables air to move through the roof vent blind 102 by providing a substantially unobstructed space for air to flow through. The air flow conduit 204 enables air to move between the side of the roof vent blind 102 facing the roof vent 106 and the side of the roof vent blind 102 facing the interior of the recreational vehicle by providing a substantially unobstructed space for air to flow through.

The roof vent blind 102 may be configured to enable air flow through the roof vent blind 102, while substantially reducing light transmission through the roof vent blind 102.

The roof vent blind 102 may comprise substantially opaque material configured to reduce light transmission into the interior of the recreational vehicle through the roof vent 106. The roof vent blind 102 may comprise opaque material configured to reduce light transmission into the interior of the recreational vehicle through the roof vent 106.

In this context opacity is a property which describes blocking the passage of radiant energy and especially light. Opacity may also be a measure of impenetrability to electromagnetic radiation, especially visible light.

Opacity may be defined mathematically as 0=100% (1−I(x)/I₀), where I(x) is the intensity of light at distance x and lo is the intensity of light at x=0.

The roof vent blind 102 may comprise opaque material with an opacity of 100%. The roof vent blind 102 may comprise opaque material with an opacity of greater than at least one of: 99.9%; 99.5%; 97.5%; 95%; 90%; 80%; 75%; 50%.

The roof vent blind 102 may be sized and shaped to reduce light transmission into the interior of the recreational vehicle through the roof vent 106.

The roof vent blind 102 may at least partially cover the interior footprint of the roof vent 106. The roof vent blind 102 may cover the majority of interior footprint of the roof vent 106. The roof vent blind 102 may substantially cover the interior footprint of the roof vent 106.

The footprint of the roof vent blind 102 may be more than at least one of: 50% of the area of the interior footprint of the roof vent 106; 70% of the area of the interior footprint of the roof vent 106; 90% of the area of the interior footprint of the roof vent 106; 95% of the area of the interior footprint of the roof vent 106; 100% of the area of the interior footprint of the roof vent 106.

The footprint of the roof vent blind 102 may cover more than at least one of: 50% of the area of the interior footprint of the roof vent 106; 70% of the area of the interior footprint of the roof vent 106; 90% of the area of the interior footprint of the roof vent 106; 95% of the area of the interior footprint of the roof vent 106; 100% of the area of the interior footprint of the roof vent 106.

In the example of FIG. 1 the footprint of the roof vent blind 102 is substantially equivalent to the area of the interior footprint of the roof vent 106. In the example of FIG. 1 the footprint of the roof vent blind 102 substantially covers the interior footprint of the roof vent 106.

The roof vent blind 102 may comprise non-reflective material. The non-reflective material may comprise at least one of: nano-fabric; flocking; any other suitable material. The non-reflective material may comprise stage black. The non-reflective material may comprise nano-material. The non-reflective material may have an average reflectance of less than at least one of: 10%; 5%; 2%; 1%; 0.5%; 0.2%; 0.1%; 0.05%; 0.02%; 0.01%. The non-reflective material may have an integrated total reflectance of less than at least one of: 10%; 5%; 2%; 1%; 0.5%; 0.2%; 0.1%; 0.05%; 0.02%; 0.01%.

Reflectance of a surface may be defined as R=Φₑ^{r}/Φₑⁱ, where Φₑ^{r} is the radiant flux reflected by the surface and Φₑⁱ is the radiant flux received by the surface.

The term nano-fabric in this context denotes a fabric comprising nano-materials. Nano-materials are materials comprising particles or constituents of nanoscale dimensions (for example less than 100-900 nm). Nano-materials may also be materials produced using nanotechnology.

An example of a non-reflective nano-fabric may be nano-fabric stage black. Non-reflective nano-materials may comprise carbon nanotubes.

The roof vent blind 102 may comprise at least one of: a substantially flexible material; a substantially rigid material. The roof vent blind 102 may comprise at least one of: a flexible material; a rigid material. The roof vent blind 102 may comprise at least one of: fabric; polymer; bamboo; any other suitable material. The process of manufacturing the roof vent blind 102 may comprise at least one of: a moulding process; any other suitable manufacturing process.

Different portions of the roof vent blind 102 may comprise different materials.

The use of a substantially flexible and/or flexible material may make it easier for a user to install and remove the roof vent blind 102. The use of a substantially flexible and/or flexible material may make it easier for a user to store the roof vent blind 102.

The use of a substantially rigid and/or rigid material may make the roof vent blind 102 more durable. The use of a substantially rigid material and/or a rigid material may make the roof vent blind 102 more structurally stable.

The roof vent blind 102 may comprise a substantially lightweight material. The roof vent blind 102 may comprise a lightweight material. The use of a lightweight material may make it easier for a user to install and remove the roof vent blind 102.

FIG. 2 shows a lateral view of the example roof vent blind 102 for a recreational vehicle from FIG. 1, coupled to a roof vent 106. The roof vent cover 202 depicted in FIG. 2 is in an open position. In FIG. 2 the example roof vent blind 102 for a recreational vehicle comprises a cover portion 104, configured to suspend below a roof vent 106 and at least partially cover the interior footprint of the roof vent 106.

In the example of FIG. 2 the footprint of the roof vent blind 102 substantially covers the interior footprint of the roof vent 106.

The cover portion 104 may be configured to substantially reduce light transmission into the interior of the recreational vehicle through the roof vent 106. The cover portion 104 may comprise substantially opaque material configured to reduce light transmission into the interior of the recreational vehicle through the roof vent 106. The cover portion 104 may comprise opaque material configured to reduce light transmission into the interior of the recreational vehicle through the roof vent 106. The cover portion 104 may be sized and shaped to reduce light transmission into the interior of the recreational vehicle through the roof vent 106.

In FIG. 2 the example roof vent blind 102 comprises an air flow portion 108, and the air flow portion 108 comprises an air flow conduit 204. The air flow conduit 204 may be configured to enable air flow between the interior and exterior of the recreational vehicle through the roof vent 106, while substantially reducing light transmission into the interior of the recreational vehicle through the roof vent 106.

In the example roof vent blind 102 shown in FIG. 2, the air flow conduit 204 comprises an aperture. The air flow conduit 204 may comprise at least one of: an air maze 302 (see FIG. 3); an aperture; any other suitable air flow conduit 204.

The aperture enables air to move through the air flow conduit 204 by providing a substantially unobstructed space for air to flow through. The aperture enables air to move between the side of the air flow portion 108 facing the roof vent 106 and the side of the air flow portion 108 facing the interior of the recreational vehicle by providing a substantially unobstructed space for air to flow through.

The air flow conduit 204 may be substantially equivalent in size to the air flow portion 108. The air flow conduit 204 may be equivalent in size to the air flow portion 108. The air flow conduit 204 may be substantially smaller in size than the air flow portion 108. The air flow conduit 204 may be smaller in size than the air flow portion 108.

The area of the air flow conduit 204 may be substantially equivalent to the area of the air flow portion 108. The area of the air flow conduit 204 may be greater that at least one of: 50% of the area of the air flow portion 108; 70% of the area of the air flow portion 108; 90% of the area of the air flow portion 108; 95% of the area of the air flow portion 108.

In FIG. 2 the example roof vent blind 102 is coupled to the ceiling of the recreational vehicle. In FIG. 2 the example roof vent blind 102 comprises a first coupling portion 2061 and a second coupling portion 2062 configured to couple to couple to the ceiling of the recreational vehicle.

The roof vent blind 102 may be configured to be detachably coupled to the ceiling of the recreational vehicle. The roof vent blind 102 may be configured to be detachably coupled to the ceiling of the recreational vehicle at least partially surrounding the interior footprint of the roof vent 106. The roof vent blind 102 may be configured to be detachably coupled to the ceiling of the recreational vehicle using hook and eye coupling means.

The roof vent blind 102 may be configured to be detachably coupled to the frame of the roof vent 106. The roof vent blind 102 may be configured to be detachably coupled to the frame of the roof vent 106 using hook and eye coupling means. The ceiling of the recreational vehicle may comprise the frame of the roof vent 106.

Detachably coupled in this context denotes that no specialist tools, no specialist knowledge and/or no significant forces are required to install or remove the roof vent blind 102. Detachably coupled in this context further denotes that the roof vent blind 102 can be installed or removed without substantially damaging the roof vent blind 102.

One advantage of the roof vent blind 102 being configured to be detachably coupled is that roof vent blind 102 can be easily removed for cleaning, transport and/or storage. A further advantage of the roof vent blind 102 being configured to be detachably coupled is that roof vent blind 102 can easily be removed to increase the amount of light that pass into the interior of the recreational vehicle through the roof vent 106.

FIG. 3 shows a lateral view of the example roof vent blind 102 for a recreational vehicle from FIG. 1 and FIG. 2, coupled to a roof vent 106. The roof vent cover 202 depicted in FIG. 3 is in an open position. In the example roof vent blind 102 shown in FIG. 3, the air flow conduit 204 comprises an air maze 302.

The air maze 302 may comprise at least one light baffle. The air maze 302 may comprise at least one light baffle, and the light baffle 304 may comprise at least one air flow aperture 306. The air flow aperture 306 may comprise an opening in the light baffle 304. The height of the opening may be, at least one of: substantially equivalent to the height of the light baffle 304; less than the height of the light baffle 304. The height of the opening may be, at least one of: equivalent to the height of the light baffle 304; less than the height of the light baffle 304.

The at least one air flow aperture 306 may be configured to enable air flow through the at least one light baffle 304.

A baffle is a device (such as a plate, wall, or screen) to deflect, check, or regulate flow or passage (as of a fluid, light, or sound). As such, a light baffle 304 is a device configured to deflect, check, or regulate the passage of light.

The air maze 302 may comprise two or more light baffles 304. The air maze 302 may comprise two or more light baffles 304, and the light baffles 304 may be configured to enable air flow between at least one air flow aperture 306₁ of a first light baffle 304₁ and at least one air flow aperture 306₂ of a second light baffle 304₂.

The air maze 302 may comprise two or more light baffles 304, and the light baffles 304 may be configured to form an air flow channel between at least one air flow aperture 306₁ of a first light baffle 304₁ and at least one air flow aperture 306₁ of a second light baffle 304₂. The air flow channel may be configured to enable air flow between the two more light baffles 304. The air flow channel may provide a substantially unobstructed space for air to flow through.

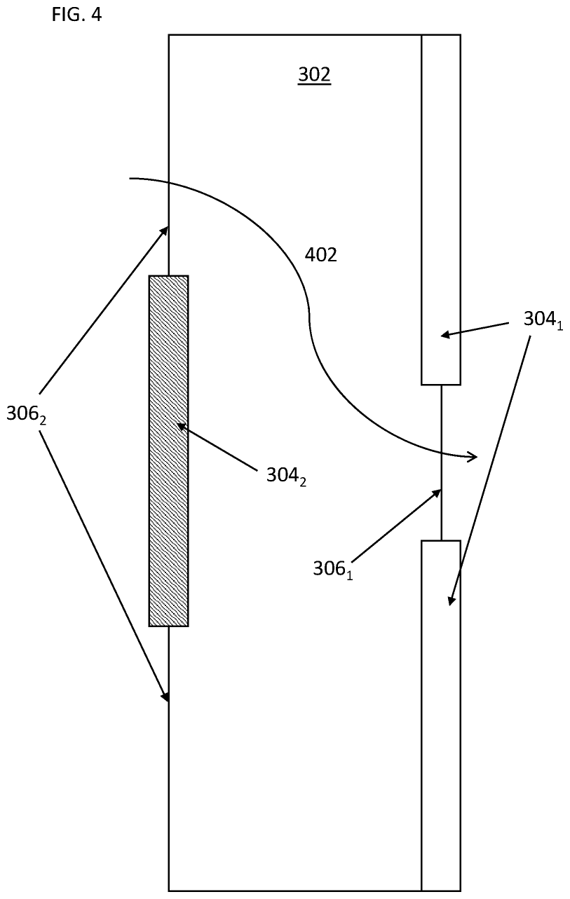

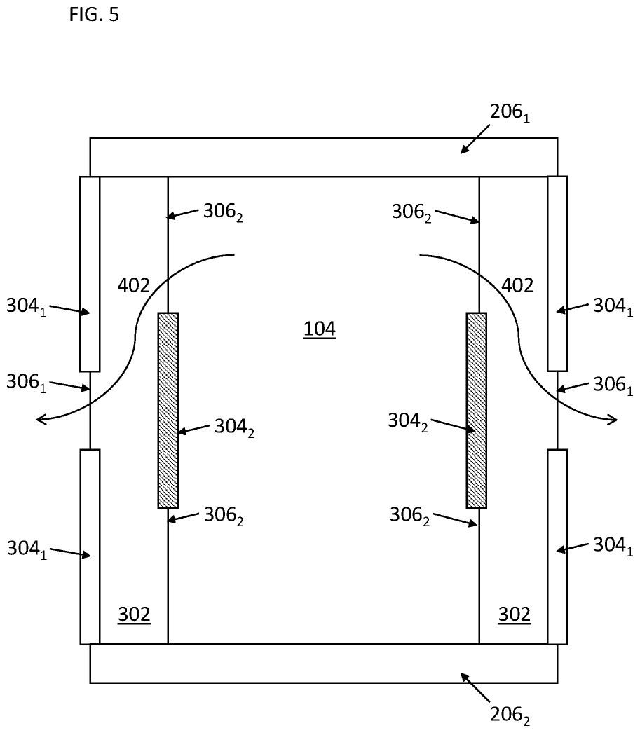

In the example shown in FIG. 3 the air maze 302 comprises two light baffles 304. The first light baffle 304₁ comprises one air flow aperture 306₁ and the second light baffle 304₂ comprises two air flow apertures 306₂ (see FIGS. 4 and 5).

In the example shown in FIG. 3 the light baffles 304 are elongate, with a substantially straight upper edge configured fit flush against the ceiling or the roof vent 106 frame and curved lower edge configured to shaped to fit flush against the cover portion 104.

In other embodiments the light baffles 304 may comprise a substantially straight upper edge and a straight lower edge.

The air maze may comprise two or more light baffles 304, and the light baffles 304 are configured such that at least one air flow aperture 306₁ of a first light baffle 304₁ is positionally offset with respect to at least one air flow aperture 306₂ of a second light baffle 304₂.

The air maze 302 may comprise two or more light baffles 304, and the light baffles 304 may be configured such that the at least one air flow aperture 306₁ of a first light baffle 304₁ is positionally offset with respect to the at least one air flow aperture 306₂ of an adjacent light baffle 304.

In this context positionally offset may denote the arrangement of air flow apertures 306 wherein the air flow apertures 306 are not aligned with respect to a direction normal to the lengths of the light baffles 304 comprising the air flow apertures 306.

In this context positionally offset may denote the arrangement of air flow apertures 306 wherein the footprints of the air flow apertures 306 are substantially non-overlapping with respect to a direction normal to the lengths of the light baffles 304 comprising the air flow apertures 306.

In the context of FIG. 3 positionally offset denotes that the footprint of the air flow aperture 306₁ of the first light baffle 304₁ does not substantially overlap with the footprints of the air flow apertures 306₂ of the second light baffle 304₂ when viewed along a vector pointing straight into the page (normal to the plane of the page).

In the context of FIGS. 4 and 5 positionally offset denotes that the footprint of the air flow aperture 306₁ of the first light baffle 304₁ does not substantially overlap with the footprints of the air flow apertures 306₂ of the second light baffle 304₂ when viewed along a horizontal vector in the plane of the page.

The air maze 302 may comprise two or more light baffles 304, and the light baffles 304 may be configured to obstruct straight-line paths through the roof vent 106 and the air maze 302.

The air maze 302 may comprise two or more light baffles 304, and the light baffles 304 may be configured such that there is no unobstructed straight-line path through the roof vent 106 and the air maze 302.

The air maze 302 may comprise two or more light baffles 304, and wherein the light baffles 304 may be configured to substantially reduce light transmission through the air maze 302. The air maze 302 may comprise two or more light baffles 304, and wherein the light baffles 304 may be configured to reduce light transmission through the air maze 302.

The light baffles 304 may comprise substantially opaque material. The light baffles 304 may comprise opaque material.

The light baffles 304 may comprise non-reflective material. The non-reflective material may comprise at least one of: nano-fabric; flocking. The non-reflective material may have an average reflectance of less than at least one of: 10%; 5%; 2%; 1%; 0.5%; 0.2%; 0.1%; 0.05%; 0.02%; 0.01%. The non-reflective material may have an integrated total reflectance of less than at least one of: 10%; 5%; 2%; 1%; 0.5%; 0.2%; 0.1%; 0.05%; 0.02%; 0.01%.

In FIGS. 1-3 the example roof vent blind 102 is shown to have the form of a catenary, however the roof vent blind could have any other suitable form. For example, the example roof vent blind 102 could be configured to have the form of at least one of: a cylindrical segment; a parabolic cylinder; a paraboloid; a cube; a cuboid; a polygonal prism; a polygonal prism segment; a spherical segment; any other suitable form.

FIG. 4 shows a top-down view of the air maze 302 shown in FIG. 3. The curved arrow 402 shows an air flow path through a substantially unobstructed space which would enable air flow from the left-hand side of the air maze 302 to the right-hand side of the air maze 302.

FIG. 5 shows a top-down view of the example roof vent blind 102 for a recreational vehicle from FIG. 1, FIG. 2 and FIG. 3, comprising two air mazes 302 as depicted in FIG. 4.

The curved arrows 402 show air flow paths through substantially unobstructed spaces which would enable air flow from the central portion of the air maze 302 to outside the air maze 302.

The roof vent blind 102 may be configured for use with a roof vent 106 comprising at least one roof vent fan. The roof vent fan may be configurable for high volumetric air flow rate operation. The roof vent fan may be configurable for operation with a high volumetric air flow rate. The roof vent fan may comprise a MaxxFan®.

A high volumetric air flow rate may comprise a volumetric air flow rate greater than at least one of: 0.1 m³/s; 0.2 m³/s; 0.5 m³/s; 1.0 m³/s; 1.5 m³/s; 2 m³/s; 5 m³/s. A high volumetric air flow rate may provide enhanced cooling to the interior of the recreational vehicle. A high volumetric air flow rate may provide improved comfort to the occupants of the recreational vehicle. A high volumetric air flow rate may reduce humidity in the interior of the recreational vehicle.

The roof vent blind 102 may be configured to substantially reduce light transmission into the interior of the recreational vehicle through the roof vent 106 when the roof vent fan is configured for operation with a high a high volumetric air flow rate. The air flow conduits 204 may be sized and shaped for use with a roof vent 106 comprising at least one roof vent fan.

The recreational vehicle may comprise at least one of: a caravan; a campervan; a motorhome; a coach; a fifth-wheel trailer; a pop-up camper; a truck camper; any other suitable vehicle.

Where a structural feature has been described, it may be replaced by means for performing one or more of the functions of the structural feature whether that function or those functions are explicitly or implicitly described.

The term ‘comprise’ is used in this document with an inclusive not an exclusive meaning. That is any reference to X comprising Y indicates that X may comprise only one Y or may comprise more than one Y. If it is intended to use ‘comprise’ with an exclusive meaning then it will be made clear in the context by referring to “comprising only one . . . ” or by using “consisting”.

In this description, the wording ‘connect’, ‘couple’ and ‘communication’ and their derivatives mean operationally connected/coupled/in communication. It should be appreciated that any number or combination of intervening components can exist (including no intervening components), i.c., so as to provide direct or indirect connection/coupling/communication. Any such intervening components can include hardware and/or software components.

As used herein, the term “determine/determining” (and grammatical variants thereof) can include, not least: calculating, computing, processing, deriving, measuring, investigating, identifying, looking up (for example, looking up in a table, a database or another data structure), ascertaining and the like. Also, “determining” can include receiving (for example, receiving information), accessing (for example, accessing data in a memory), obtaining and the like. Also, “determine/determining” can include resolving, selecting, choosing, establishing, and the like.

In this description, reference has been made to various examples. The description of features or functions in relation to an example indicates that those features or functions are present in that example. The use of the term ‘example’ or ‘for example’ or ‘can’ or ‘may’ in the text denotes, whether explicitly stated or not, that such features or functions are present in at least the described example, whether described as an example or not, and that they can be, but are not necessarily, present in some of or all other examples. Thus ‘example’, ‘for example’, ‘can’ or ‘may’ refers to a particular instance in a class of examples. A property of the instance can be a property of only that instance or a property of the class or a property of a sub-class of the class that includes some but not all of the instances in the class. It is therefore implicitly disclosed that a feature described with reference to one example but not with reference to another example, can where possible be used in that other example as part of a working combination but does not necessarily have to be used in that other example.

Although examples have been described in the preceding paragraphs with reference to various examples, it should be appreciated that modifications to the examples given can be made without departing from the scope of the claims.

Features described in the preceding description may be used in combinations other than the combinations explicitly described above.

Although functions have been described with reference to certain features, those functions may be performable by other features whether described or not.

Although features have been described with reference to certain examples, those features may also be present in other examples whether described or not.

The term ‘a’, ‘an’ or ‘the’ is used in this document with an inclusive not an exclusive meaning. That is any reference to X comprising a/an/the Y indicates that X may comprise only one Y or may comprise more than one Y unless the context clearly indicates the contrary. If it is intended to use ‘a’, ‘an’ or ‘the’ with an exclusive meaning then it will be made clear in the context. In some circumstances the use of ‘at least one’ or ‘one or more’ may be used to emphasis an inclusive meaning but the absence of these terms should not be taken to infer any exclusive meaning.

The presence of a feature (or combination of features) in a claim is a reference to that feature or (combination of features) itself and also to features that achieve substantially the same technical effect (equivalent features). The equivalent features include, for example, features that are variants and achieve substantially the same result in substantially the same way. The equivalent features include, for example, features that perform substantially the same function, in substantially the same way to achieve substantially the same result.

In this description, reference has been made to various examples using adjectives or adjectival phrases to describe characteristics of the examples. Such a description of a characteristic in relation to an example indicates that the characteristic is present in some examples exactly as described and is present in other examples substantially as described.

The above description describes some examples of the present disclosure however those of ordinary skill in the art will be aware of possible alternative structures and method features which offer equivalent functionality to the specific examples of such structures and features described herein above and which for the sake of brevity and clarity have been omitted from the above description. Nonetheless, the above description should be read as implicitly including reference to such alternative structures and method features which provide equivalent functionality unless such alternative structures or method features are explicitly excluded in the above description of the examples of the present disclosure.

Whilst endeavoring in the foregoing specification to draw attention to those features believed to be of importance it should be understood that the Applicant may seek protection via the claims in respect of any patentable feature or combination of features hereinbefore referred to and/or shown in the drawings whether or not emphasis has been placed thereon.

What is claimed is:

1. A roof vent blind for a recreational vehicle, the roof vent blind comprising:
a cover portion, configured to suspend below a roof vent and at least partially cover an interior footprint of the roof vent; and
at least one air flow portion,
wherein the at least one air flow portion comprises at least one air flow conduit configured to enable air flow between an interior and an exterior of the recreational vehicle through the roof vent.

2. The roof vent blind of claim 1, wherein the at least one air flow conduit comprises an aperture.

3. The roof vent blind of claim 1, wherein the at least one air flow conduit comprises an air maze.

4. The roof vent blind of claim 3, wherein the air maze comprises at least one light baffle, and the at least one light baffle comprises at least one air flow aperture.

5. The roof vent blind of claim 3, wherein the air maze comprises two or more light baffles.

6. The roof vent blind of claim 3, wherein the air maze comprises two or more light baffles, and the two or more light baffles are configured to enable air flow between at least one air flow aperture of a first light baffle and at least one air flow aperture of a second light baffle.

7. The roof vent blind of claim 3, wherein the air maze comprises two or more light baffles, and the two or more light baffles are configured such that at least one air flow aperture of a first light baffle is positionally offset with respect to at least one air flow aperture of a second light baffle.

8. The roof vent blind of claim 3, wherein the air maze comprises two or more light baffles, and the two or more light baffles are configured to obstruct straight-line paths through the roof vent and the air maze.

9. The roof vent blind of claim 1, wherein the at least one air flow conduit is one of:
substantially equivalent in size to the at least one air flow portion; or
substantially smaller in size than the at least one air flow portion.

10. The roof vent blind of claim 1, wherein the roof vent blind comprises non-reflective material.

11. The roof vent blind of claim 10, wherein the non-reflective material comprises at least one of:
nano-fabric; or
flocking.

12. The roof vent blind of claim 1, wherein the roof vent blind is configured to be detachably coupled to a ceiling of the recreational vehicle.

13. The roof vent blind of claim 1, wherein the roof vent blind is configured to be detachably coupled to a ceiling of the recreational vehicle using hook and eye coupling means.

14. The roof vent blind of claim 1, wherein the roof vent blind is configured to be detachably coupled to a frame of the roof vent.

15. The roof vent blind of claim 1, wherein the roof vent blind is configured for use with the roof vent, wherein the roof vent comprises at least one roof vent fan.

16. The roof vent blind of claim 15, wherein the at least one roof vent fan is configurable for high volumetric air flow rate operation.

17. The roof vent blind of claim 1, wherein the roof vent blind is configured to enable air flow between the interior and exterior of the recreational vehicle through the roof vent, while substantially reducing light transmission into the interior of the recreational vehicle through the roof vent.

18. The roof vent blind of claim 1, wherein the roof vent blind comprises substantially opaque material configured to reduce light transmission into the interior of the recreational vehicle through the roof vent.

19. The roof vent blind of claim 1, wherein the roof vent blind is sized and shaped to reduce light transmission into the interior of the recreational vehicle through the roof vent.

20. The roof vent blind of claim 1, wherein the recreational vehicle comprises at least one of:
a caravan;
a campervan;
a motorhome;
a coach;
a fifth-wheel trailer;
a pop-up camper; or
a truck camper.
